(19) United States
(12) Patent Application Publication
(10) Pub. No.: US 2002/0104453 A1
(43) Pub. Date: Aug. 8, 2002

(54) Air bearing assembly

(76) Inventors: Martin Lee, Saratoga, CA (US); Michael Sogard, Menlo Park, CA (US)

Correspondence Address: MORRISON & FOERSTER LLP, 2000 PENNSYLVANIA AVE, NW, SUITE 5500, WASHINGTON, DC, 20006-1888, US

(21) Appl. No.: 09/773,818

(22) Filed: Feb. 2, 2001

(51) Int. Cl. B41F 1/18; B41F 7/00

(52) U.S. Cl. 101/450.1

(57) ABSTRACT

A stage device comprising a base, a stage positioned adjacent to the base and movable relative to the base, and a bearing assembly. The bearing assembly includes at least one fluid bearing interposed between the base and the stage for supporting the stage on the base and movable relative to the base and stage. A method of the present invention is for positioning a stage within a lithography system and comprises placing the fluid bearing between the stage and the base and moving the stage and the bearing in a first direction.

### FIELD OF THE INVENTION

This invention relates generally to stage devices for precision movement and location, such as used in photolithography systems, and more particularly, to bearings used with the stage device.

### BACKGROUND OF THE INVENTION

The need for precise positioning of an object is required in many fields of application, including lithography used in forming integrated circuits in semiconductor manufacturing. Various systems and methods have been developed to attempt to improve positioning and movement of a semiconductor wafer in the lithography process. As the circuit density of integrated circuits increases and feature size decreases, the accuracy in the methods for laying down the circuits on the semiconductor wafer must improve. One way to increase the accuracy is to reduce system complexity and size of the stage device, thus providing greater stability of motion during positioning of the wafer.

Air bearing systems are often used to provide smooth and accurate movement between a stage and another planar surface. An example of a stage device for use in semiconductor processing equipment is disclosed in U.S. Pat. No. 5,760,564. The stage assembly includes two guide rails (one movable in the x direction and the other movable in the y direction). A plurality of air bearings are attached to the guide rails and stage for movement of the guide rails and stage relative to the base. Since the bearings are attached to the stage and travel with the stage, the base must be at least as large as the diameter of the bearing plus the entire stroke (travel) of the stage. This results in a large base and stage.

Furthermore, conventional stage devices often include stacked stages to provide six degrees of freedom of movement of the stage. For example, U.S. Pat. No. 5,623,853 discloses a motor which obtains six degrees of freedom by stacking multiple motors capable of movement in only two dimensions within a plane. These stacked arrangements have a number of drawbacks. For example, each additional level adds mass requiring additional power for the electric motors supporting that level to move the stage. Also the complicated joint connections degrade accuracy of positioning of the stage and build in resonant frequencies. Finally, some applications may require a relatively thin stage. In this case stacked stage designs may be unacceptable.

There is, therefore, a need for a compact stage device which obviates the need for stacked stages and provides a greater stability of motion for increased positioning accuracy.

### SUMMARY OF THE INVENTION

The stage device of the present invention provides a compact device for positioning a stage relative to a base of a lithography system.

The stage device comprises a base, a stage positioned adjacent to the base and movable relative to the base, and a bearing assembly. The bearing assembly comprises at least one fluid bearing interposed between the base and the stage for supporting the stage on the base and movable relative to the base and the stage.

In one embodiment the bearing assembly comprises a plurality of fluid bearings attached to a retainer. The retainer is driven by a motor and follows the motion of the stage which is driven by a separate motor operating at approximately twice the speed of the bearing motor.

In another embodiment, the bearing assembly is movable in a direction generally orthogonal to a plane of the base.

An exposure apparatus of the present invention comprises a frame, an optical system mounted on the frame, a base, and a stage supported by the base. The stage is positioned adjacent to the base and movable relative thereto. The exposure apparatus further comprises a bearing assembly comprising at least one fluid bearing interposed between the base and the stage for supporting the stage on the base and movable relative to the base and the stage.

A method of the present invention is for positioning a stage within a lithography system having an optical system for imaging a pattern onto an article. The stage supports the article and is located adjacent to a base and movable relative thereto. The method comprises placing a fluid bearing movable relative to the stage and the base, between the stage and base and moving the stage and bearing in a first direction relative to the base.

The above is a brief description of some deficiencies in the prior art and advantages of the present invention. Other features, advantages, and embodiments of the invention will be apparent to those skilled in the art from the following description, drawings, and claims.

### BRIEF DESCRIPTION OF THE DRAWINGS

FIG. 1 is a schematic of a stage device of the present invention;

FIG. 2 is a schematic of a lithography apparatus utilizing the stage device of FIG. 1;

FIG. 3 is a side view of the stage device of FIG. 1;

FIG. 4 is a partial side view of a second embodiment of the stage device of FIG. 1;

FIG. 5 is a side view of an air bearing assembly of the stage device of FIG. 4;

FIG. 6 is an alternate embodiment of the air bearing assembly of FIG. 5;

FIG. 7 is a schematic of a third embodiment of the stage assembly of FIG. 1;

FIG. 8 is a perspective of an air bearing of the stage assembly of FIG. 7;

FIG. 9 is cross-sectional view of the air bearing of FIG. 8; and

FIG. 10 is a partial side view of a fourth embodiment of the stage assembly of FIG. 1.

FIG. 11 is a side view of a fifth embodiment of the stage assembly of FIG. 1;

FIG. 12 is a top view of a fifth embodiment of the stage assembly of FIG. 1;

FIG. 13 is a second side view of a fifth embodiment of the stage assembly of FIG. 1;

FIG. 14 is a side view of a sixth embodiment of the stage assembly of FIG.

FIG. 15 is a top view of a sixth embodiment of the stage assembly of FIG.

FIG. 16 is a second side view of a sixth embodiment of the stage assembly of FIG. 1

FIG. 17 is a side view of a seventh embodiment of the stage assembly of FIG. 1;

FIG. 18 is a top view of a seventh embodiment of the stage assembly of FIG. 1;

FIG. 19 is a second side view of a seventh embodiment of the stage assembly of FIG. 1;

Corresponding reference characters indicate corresponding parts throughout the several views of the drawings.

### DESCRIPTION OF THE INVENTION

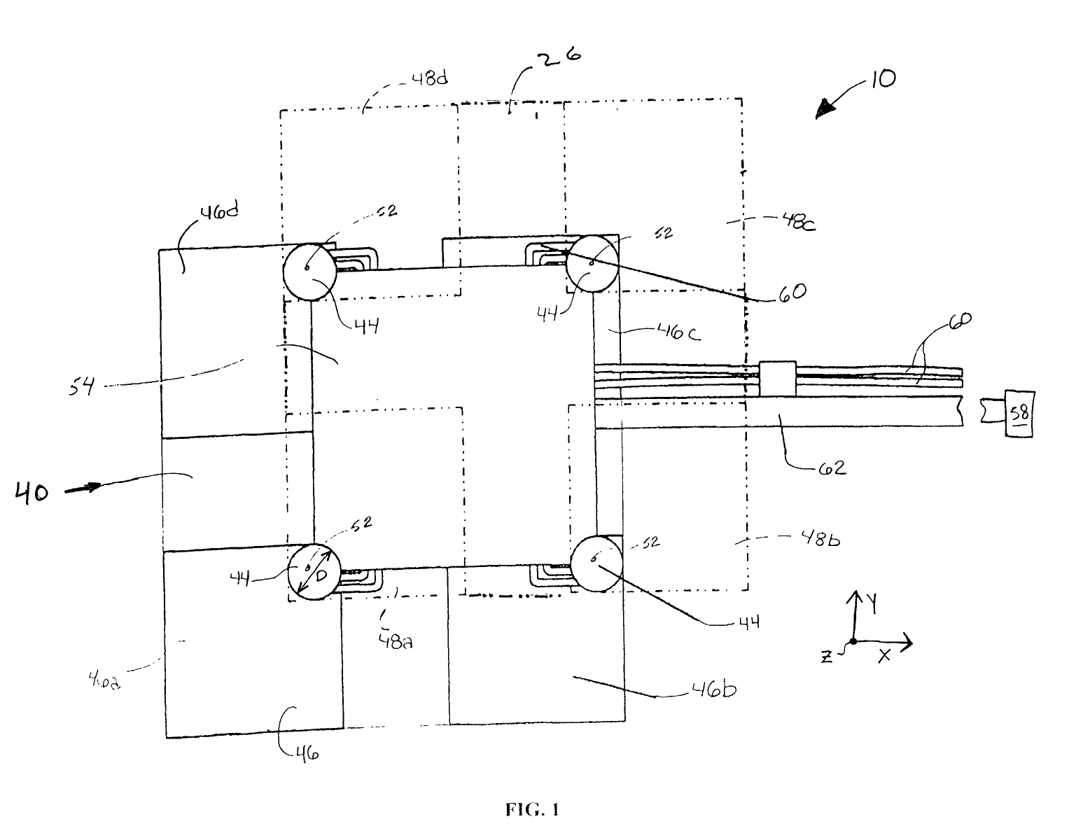

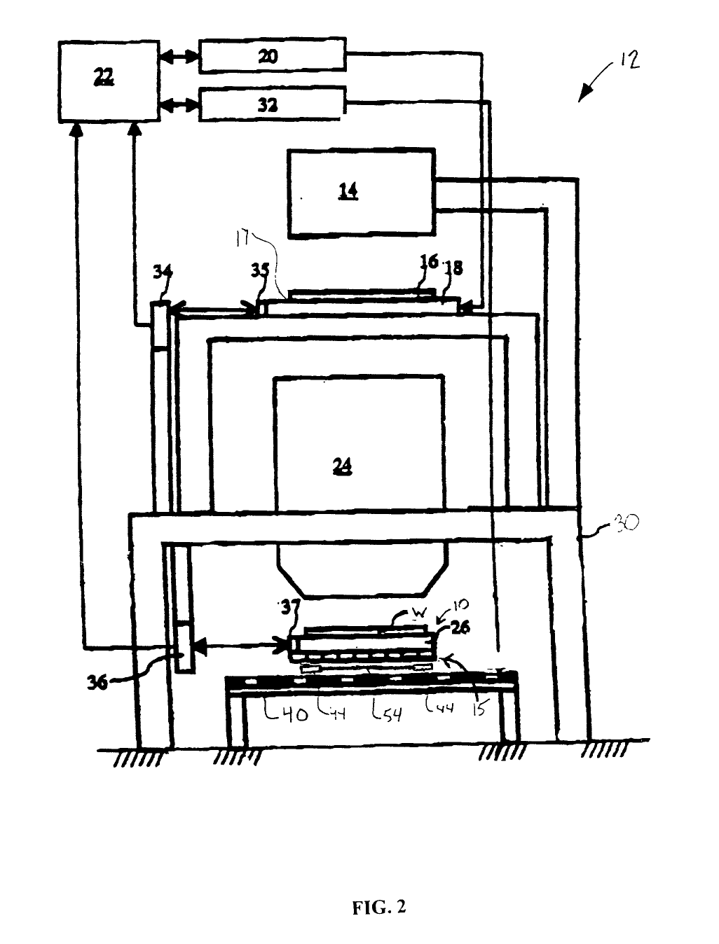

Referring now to the drawings, and first to FIG. 1, a stage device, generally indicated at 10, of the present invention is shown. The stage device is particularly advantageous for applications such as scanning photolithography where the stage holds a semiconductor wafer which is being scanned by a photolithography machine. FIG. 2 is a schematic illustrating a photolithography (exposure) apparatus, generally indicated at 12, incorporating the stage device 10 of the present invention. The photolithography apparatus 12 generally includes an illumination system 14 and at least one linear or planar motor 15 for moving a wafer W. The illumination system 14 projects light beams through a reticle 16 which is supported and scanned using a reticle stage 18. The light is focused through a system of lenses (optical system) 24 supported on a frame 30. The light exposes a pattern formed in the reticle 16 onto a layer of photoresist on the wafer

The wafer W is positioned under the optical system 24 and held by a vacuum chuck (not shown) which is supported by a wafer stage 26. The wafer stage 26 is preferably structured so that it may be moved in several (e.g., three to six) degrees of freedom by the motor 15, or the combination of the motor and a bearing assembly, as further described below. The motor 15 is moved under precision control by a driver 32 and a system controller 22 to position the wafer W at a desired position and orientation, and to move the wafer relative to the projection optics 24. The control system 22 also controls driver 20 to move motor 17 which positions the reticle stage 18 and reticle 16. For precise positional information, interferometers 34, 36 and mirrors 35, 37 are provided to detect the actual position of the wafer W and reticle 16. The signals from the interferometers 34, 36 are fed to control system 22 which acts with the drivers 20, 32 and motors 15, 17 to control the position of the wafer W and reticle 16. A fine stage (not shown) may also be mounted on the stage 26 to provide finer positioning of the stage. Other elements, well known by those skilled in the art, for use in photolithography systems are not illustrated for simplicity.

It is to be understood that the present invention may be easily adapted for use in other types of exposure systems for substrate processing (e.g., projection-type photolithography system or electron-beam (EB) lithography system disclosed in U.S. Pat. No. 5,773,837) or other types of systems for processing other articles. Further details of the components within a scanning-type exposure apparatus may be referenced from U.S. Pat. Nos. 5,477,304 and 5,715,037, which are incorporated herein by reference in their entirety. It is to be understood that the present invention is not to be limited to wafer processing systems, or to step-and-scan exposure systems for wafer processing. The general reference to a step-and-scan exposure system is purely for illustrating an embodiment of an environment in which the concept of the stage device of the present invention may be advantageously adopted. Further, the stage device 10 is described below with reference to the wafer stage 26, but may also be used with the reticle stage 18.

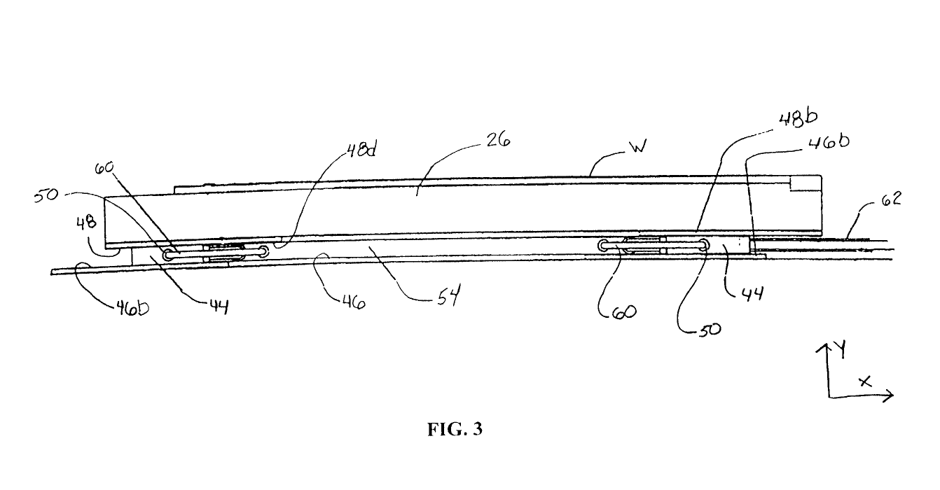

The stage device 10 of the present invention includes a stationary base 40 and the stage 26 (shown in phantom in FIG. 1) positioned adjacent to the base and movable relative to the base. The stage 26 is supported on the base 40 by a plurality of air bearings 44. The base 40 has a generally planar upper surface 46 which is substantially parallel to a generally planar lower surface 48 of the stage 26 (FIGS. 1 and 3). The bearings 44 are interposed between the upper surface 46 of the base 40 and the lower surface 48 of the stage 26 and are free to move relative to both surfaces. A typical separation between a working surface of each air bearing 44 and the opposing surfaces 46, 48 on which the air bearing slides is about 5 to 10 microns when the air bearing is operating, for example.

In conventional stage assemblies which use air bearings to support the stage, the bearings are attached to either the base or the stage. The air bearings thus travel with the stage over the entire base which requires the base to have a surface at least as large as the diameter of the bearing plus the distance of travel of the stage. Since the bearings 44 of the present invention move relative to both the base 40 and the stage 26 they only have to travel half the distance of the total stroke (travel distance) of the stage. Therefore, the lower surface 48 of the stage 26 and upper surface 46 of the base 40 over which the bearings 44 travel, only have to be as large as the bearing diameter D plus half of the total stroke of the stage, thus significantly reducing the overall size of the stage device 10.

The base 40 is supported on the frame 30 of the lithography apparatus 12 or directly on the ground (FIG. 2). The upper surface 46 of the base 40 includes four guide regions 46a-46d positioned at four comers of the base (FIGS. 1 and 3). One bearing is positioned in each guide region and moves within the guide region. The guide regions 46a-46d are preferably defined by pads attached to the upper surface 46 of the base 40. The pads are machined to provide a smooth planar finish and are preferably formed of granite or other very planar and dimensionally stable material. Alternatively, the entire upper surface 46 of the base 40 may be machined to provide a smooth planar finish rather than providing pads for the guide regions 46a-46d.

The lower surface 48 of the stage 26 similarly includes four guide regions 48a-48d (shown in phantom). Each bearing 44 is positioned between one guide region 46a-46d of the base 40 and one guide region 48a-48d of the stage 26 and moves within the guide region to cover the full travel of the stage. The guide regions 48a-48d of the stage 26 are shown in FIG. 1 positioned relative to the guide regions 46a-46d of the stage with the stage at its furthest position to the right along the x axis and its furthest position up along the y axis (as viewed in FIG. 1). Each bearing 44 is positioned at the bottom left comer of the stage guide regions 48a-48d and the top right comer of the base guide regions 46a-46d. The bearings 44 may move over the entire surface of each of the guide regions 46a-46d, 48a-48d. For example, if the stage 26 moves to the opposite end of its stroke in the x direction, while maintaining its position along the y axis, each bearing 44 would be positioned at the bottom right comer of the stage guide regions 48a-48d and the top left comers of the base guide regions 46a-46d. The bearings 44 are intended to move in the x and y directions (i.e., defined by the plane of the drawing) and may also rotate about a z axis (directed out of the page of the drawing). As described below, the bearings 44 may also move along the z-axis.

The bearings 44 are preferably non-direct contact (low friction) bearings. The bearings 44 may be air bearings or any other suitable fluid bearing. For example, gases other than air may also be used. For applications other than semiconductor processing, which do not require as clean environments, oil or water bearings may be used. If the air bearings 44 operate within a vacuum region, such as for electron beam lithography, an air bearing as disclosed in U.S. patent application Ser. No. 09/012,432, by Michael Sogard and Dennis Spicer, filed Jan. 23, 1998, (incorporated herein by reference in its entirety) may be used.

The bearings 44 are preferably cylindrical in shape and include an inlet 50 for receiving air (or other suitable fluid) under pressure from a conventional source such as a pump (FIGS. 1 and 3). A passage is formed in the bearing for passing air from the inlet 50 to two small diameter orifices 52 positioned on opposite ends of the bearing. The air exits through the orifices 52 and is distributed radially. It is to be understood that the configuration of the bearing 44 may be different than the ones disclosed herein without departing from the scope of the invention. For example, the air may exit from the bearing 44 at a plurality of openings positioned along the end of the bearing rather than the single orifice 52.

The bearings 44 are connected to a retainer (retaining member) 54 which is attached to a motor 58 for driving the retainer and bearings. As shown in FIGS. 1 and 3, the retainer 54 is a generally rectangular plate. The bearings 44 are each attached to a comer of the plate. A supply line 60 provides air to the bearings 44 and is attached to the retainer 54 for movement therewith. Supply lines 60 are routed to each corner of the retainer 54 for connection to the air bearings 44. Since the air supply lines 60 are all connected to the retainer 54 rather than the stage 26, the stage is free to move without restraint from hose connections as with conventional stage devices which have the bearings connected to and moving with the stage. As shown in FIG. 1, two supply lines 60 may be provided for each bearing 44 to provide pressurized air and a vacuum for operation of the bearing in a vacuum. For vacuum operation, a vacuum line is needed to differentially pump air from the bearing 44 so that the surrounding vacuum is unaffected (see e.g., U.S. patent application Ser. No. 09/012,432, referenced above).

A shaft 62 is connected at one end to a peripheral edge of the retainer 54 and at the opposite end to the drive motor 58 for moving the retainer and bearings 44 relative to the base 40 and stage 26. The motor 58 may be a planar or linear motor operable to move the retainer 54 in the x and y directions, for example. As discussed above, the retainer 54 does not need to follow the stage at the same speed as the stage. The motor 58 may be operable to move the retainer 54 at approximately half the velocity of the stage 26, for example. Further, the retainer motor 58 does not need to be as accurate as the stage motor 15, and may have a lower bandwidth than the stage motor. The retainer motor 58 and stage motor 15 are preferably connected to the system controller 22 which sends signals to the stage motor 15 to accurately position the stage, and to the retainer motor to follow the movement of the stage (within e.g. approximately +1-2 mm).

It is to be understood that the type of bearings 44, number of bearings, type of retainer 54 and arrangement of the bearings and retainer which make up the bearing assembly may be different than shown herein without departing from the scope of the invention. For example, the bearing assembly may comprise a single large fluid bearing or more than four bearings.

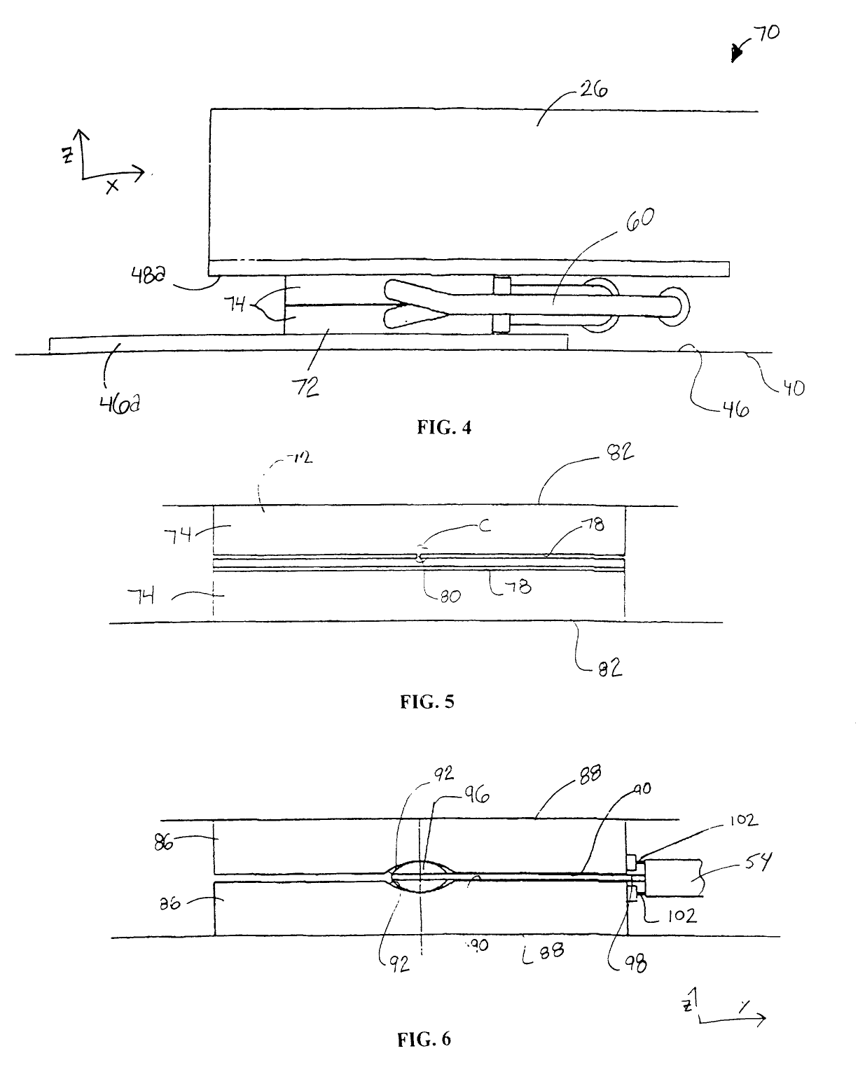

A second embodiment of the stage device, generally indicated at 70, is shown in FIG. 4. The stage device 70 includes a fluid bearing 72 comprising two bearing members 74 positioned generally concentric with one another in a stacked configuration (FIG. 5). The outer surface 82 of each bearing member 74 includes one or more orifices for delivering air as previously described. The two bearing members 74 are connected for movement together in the x and y directions but are movable relative to one another for angular rotation about the x or y axis to compensate for base and stage surfaces 46, 48 which are not precisely parallel to one another. As shown in FIG. 5, the bearing members 74 may be integrally formed together to create a single fluid bearing 72. The bearing 72 includes two pairs of notches 78 extending substantially across a diameter of the bearing generally perpendicular to one another. Each pair of notches 78 extends from an edge of the bearing to a central portion C of the bearing where the notches terminate to form a connection 80 between the bearing members 74. The notches 78 permit angular rotation of the outer surfaces 82 of the bearing 72 relative to one another.

An alternate embodiment of the bearing 72 for use in the stage device 70 of FIG. 4 is shown in FIG. 6. Bearing members 86 are similarly arranged in a stacked configuration with one bearing member spaced above the other bearing member. Each bearing member 86 includes an outer surface 88 having one or more orifices for delivery of air and an inner surface 90 having a semi-spherical recess 92 formed generally in the center of the inner surface of the bearing member. The recesses 92 are sized for receiving a bearing 96 to provide angular rotation of the bearing members 86 relative to one another about the x or y axis. The bearing 96 is connected to a small diameter rod 98 which extends along the inner surfaces 90 of the bearing members 86 and is connected to the retainer 54. The bearing members 86 are each connected to the retainer 54 with a flexible tie bar 102 which allows for limited angular rotation of the bearing members 86 relative to the retainer 54 and one another. The bearing 96 may be spherical or oblong shaped, for example, and is preferably formed of a material such as a ceramic or hard metal, which is compatible with a material of the inner surface of the bearing member 86. The flexible tie bars 102 may be formed of any suitable material such as a polymer or elastomeric material which is flexible enough to provide angular rotation between the two bearing members 86 while being rigid enough so that the bearing members remain adjacent to one another and move together in the x and y directions.

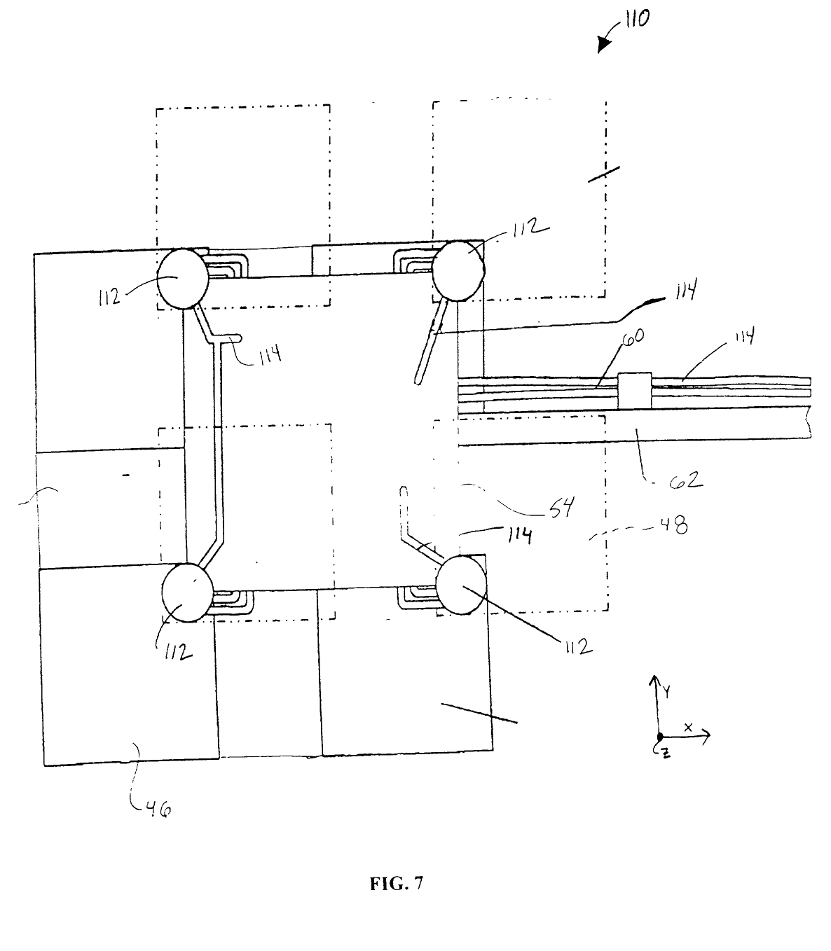

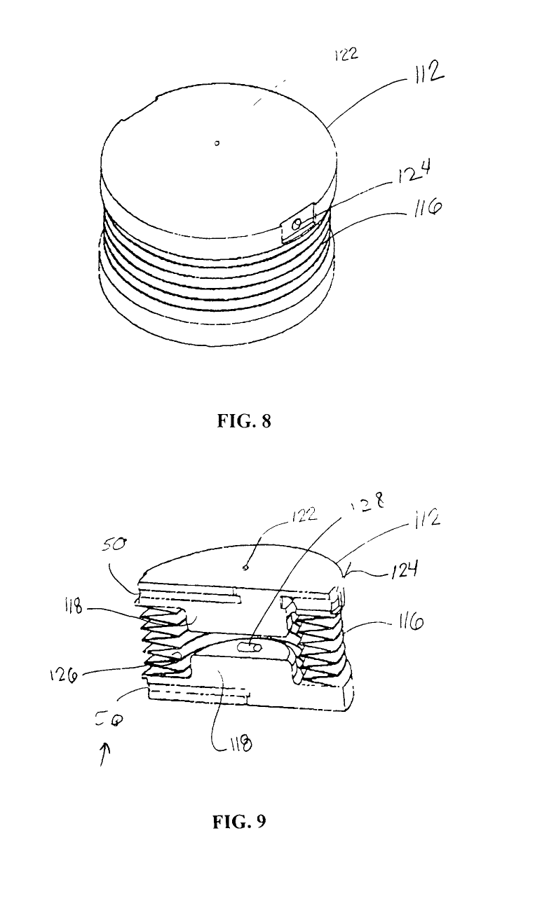

A third embodiment of the stage device, generally indicated at 110, is shown in FIG. 7 and includes bearings 112 which are adjustable in the z direction. The stage device 110 is similar to the first embodiment 10 except that hydraulic lines 114 are connected to the retainer 54 along with the air or vacuum lines 60 and extend to the bearings 112 to provide hydraulic fluid (or any other suitable fluid such as gas) to the bearings. The bearings 112 are generally cylindrical in shape and comprise a flexible side wall 116 forming a bellows (FIGS. 8 and 9). The upper and lower ends of the bearings 112 define an enclosure 118 for receiving air which is distributed through orifices 122 on the upper and lower surfaces of the bearing. Walls of the enclosures 118 and the sidewall 116 of the bearing 112 form an expandable chamber 126 of the bellows.

The hydraulic fluid lines 114 are connected to ports 124 in the bearings 112 and the hydraulic fluid is supplied by a hydraulic pump (not shown) which receives signals from a controller for increasing or reducing the height of the bearing 112 (FIGS. 7-9). In order to increase the height of the bearing 112, the pump delivers hydraulic fluid to the bearing thus increasing pressure within the chamber 126, expanding the bellows, and increasing the height of the bearing. The bearings 112 may be pressurized together to increase the overall height of the stage 26 or pressurized individually to provide rotation of the stage about the x or y axis. Three separate hydraulic inputs may be provided, with two of the bearings 112 attached to the same source, as shown in FIG. 7, to provide angular rotation of the stage 26 about both the x and y axes. Four bearings 112 are provided to maintain kinematic support of the stage so that the stage 26 maintains its stiffness, but only three different points of hydraulic inputs are required to provide angular rotation of the stage about the x and y axes. Since the bellows provides a generally compliant bearing, there is no need for the flexure couplings and bearing member arrangements shown in FIGS. 4-6. The bearings 112 automatically provide for minor tilt adjustment to compensate for any deviations of the planar surfaces 46a-46d and 48a-48d of the base 40 and stage 26.

The frequency response of the hydraulically actuated bearings will be limited by the time required for a signal to the hydraulic pump to generate a pressure change at the bearing. For small changes in height or leveling, the frequency response can be increased by immersing a piezoelectric actuator within the bearing interior which can rapidly alter the volume of a structure 128 enclosing the actuator. This structure might for example be a small bellows, sealed at both ends, with the piezoelectric actuator attached to the two ends. The residual volume within the bellows would be either a vacuum or a compressible fluid. Because of the relative incompressibility of the hydraulic fluid, and the stiffness of the bellows 116 of the bearing, these changes in volume will cause small changes in the height of the bearing.

A fourth embodiment of the stage device is shown in FIG. 10 and generally indicated at 140. The bearing 72 is the same as shown in FIG. 4, but the bearings shown in the other embodiments may also be used. Each guide region 46a-46d of the base 40 includes an adjustable platform 142 which is movable along the z axis or about the x and y axes for angular rotation (tilt) of the platform. Each guide region 46a-46d of the base 40 may include a platform 142 as shown in FIG. 10, or a single platform may be used to cover the entire upper surface 46 of the base. The four platforms 142 may move simultaneous with one another or independently for angular rotation of the stage 26. The base 40 includes a recess 146 at the location of each guide region 46a-46d and a plurality of actuation devices, generally indicated at 148, for moving the platform 142 relative to the stationary base. The actuation devices 148 each comprise a hydraulic actuator 150 to provide relatively large changes in the height or angle of the platform 142 at a low frequency, and a piezoelectric actuator 152 to provide relatively small changes in the height or angle of the platform at a higher frequency. The piezoelectric actuator 152 provides quick responsiveness which typically cannot be obtained with hydraulic or magnetically operated actuators. The piezoelectric actuator 152 is thus used for quick and accurate fine adjustments in the position of the platform 142 and the hydraulic actuator 150 is used to provide larger adjustments in platform position. A controller (not shown) adjusts the platform height and orientation according to commands sent to it.

The piezoelectric actuator 152 comprises a piezoelectric element (not shown) made of one or more piezoelectric layers which expand or contract according to charging or discharging of electricity. The hydraulic actuator 150 comprises a hydraulic piston 156 and a port 158 for receiving hydraulic fluid for actuation of the piston. The piezoelectric actuator 152 is positioned at the end of the piston 156 and moves along with the piston to exert a force on a spring biased lever 160. The lever 160 pivots about point 160a to move a plunger 164 which is attached to the lever at point 160b. The plunger extends axially through a compression spring 170. As the piston 156 extends (moves to the left as viewed in FIG. 10) an upper end of the lever 160 attached to the piston, moves to the left and pulls the plunger 164 in a downward direction, thus moving the platform downward in the z direction. As the piston 156 retracts (moves the right as viewed in FIG. 10), the lever 160 pushes the plunger 164 in an upward direction along the z axis causing the platform 142 to move in an upward direction. Similarly, the piezoelectric actuator 152 moves to the left or right to move the platform up or down in the z direction over a shorter stroke. It is to be understood that the actuation device may be different than the one described herein without departing from the scope of the invention. For example, an electromechanical actuator may be used with or without the piezoelectric actuator.

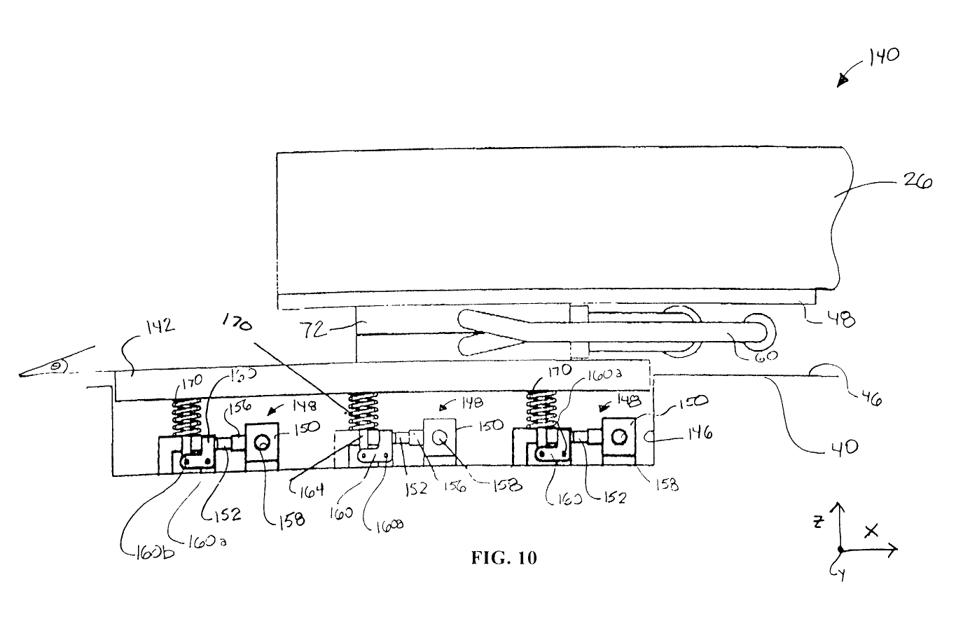

FIGS. 11, 12, and 13 describe an embodiment of the invention in which a single bearing supports the stage. The bearing itself may be of the type described in embodiment three above, so that variations in height are possible. The upper and lower bearings are connected together by parallelogram linkages 180 which ensure that the upper and lower bearing surfaces remain parallel.

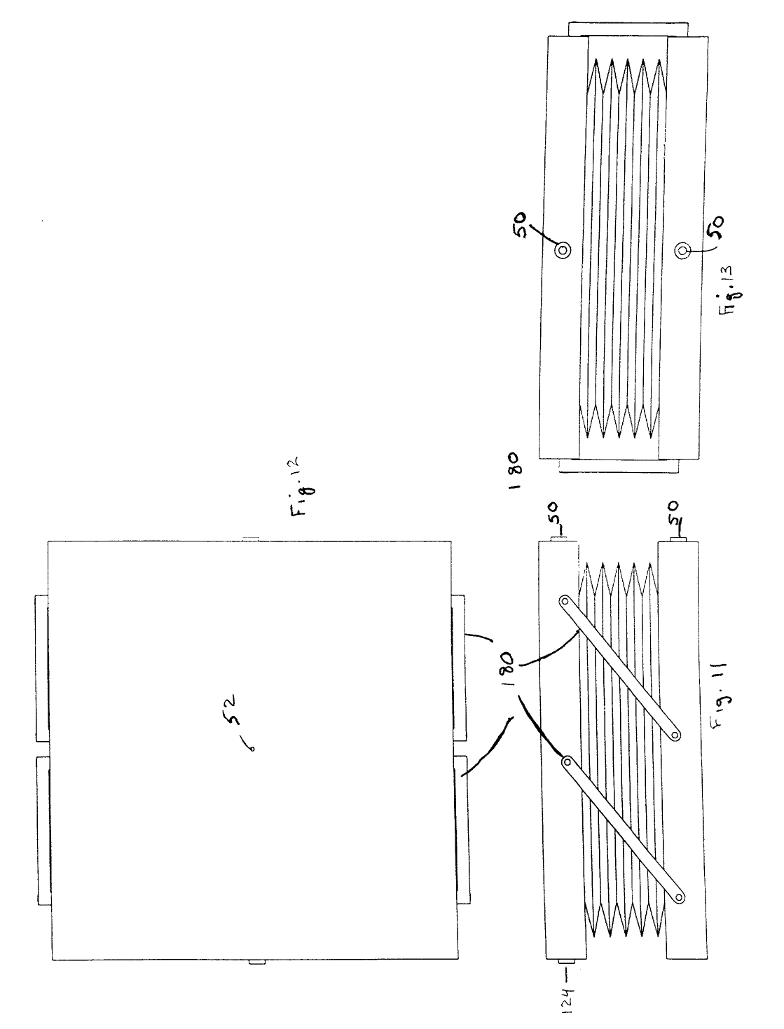

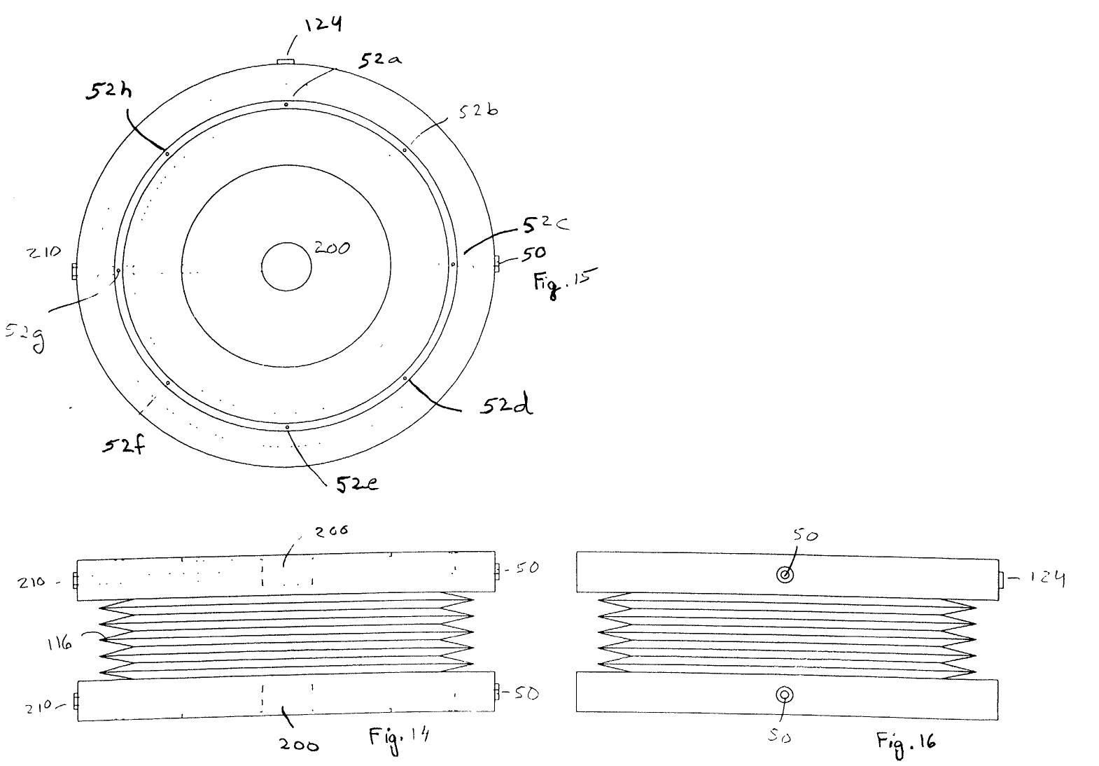

In the above embodiments, no comment has been made about preloading. The air bearings require a preload, or compressive force between the two bearing surfaces, in order to function properly. This preload can be provided by the gravitational weight of the stage. Or it can be provided by a spring or springs attached between the stage and the base. Or it can be provided by a set of bearings, similar to the ones described herein, which are placed between the top surface of the stage and a fixed upper base. The upper base is positioned vertically to impose a compressive load on the system. FIGS. 14, 15, and 16 describe a bearing embodiment, usable in air, which incorporates a vacuum preloading mechanism. The bearing incorporates the properties of the bearing 112. In addition it includes cavities 200 in the upper and lower bearing plates. When the bearing is installed between the base and stage, the cavities 200 can be evacuated through ports 210 which can be connected to a vacuum pump. Over the areas of the stage and base open to the cavity, atmospheric pressure forces the stage and upper bearing plate, and base and lower bearing plate together, providing an effective preload.

Because of the central vacuum cavity 200, the air bearing orifice 52 is replaced by an annular array of orifices 52a-52h. A plenum (not shown) connects the orifices to the gas inlet 50. The orifices are shown placed within a shallow groove 53. This provides additional lifting force, if the two bearing surfaces are pressed together initially with no bearing gap.

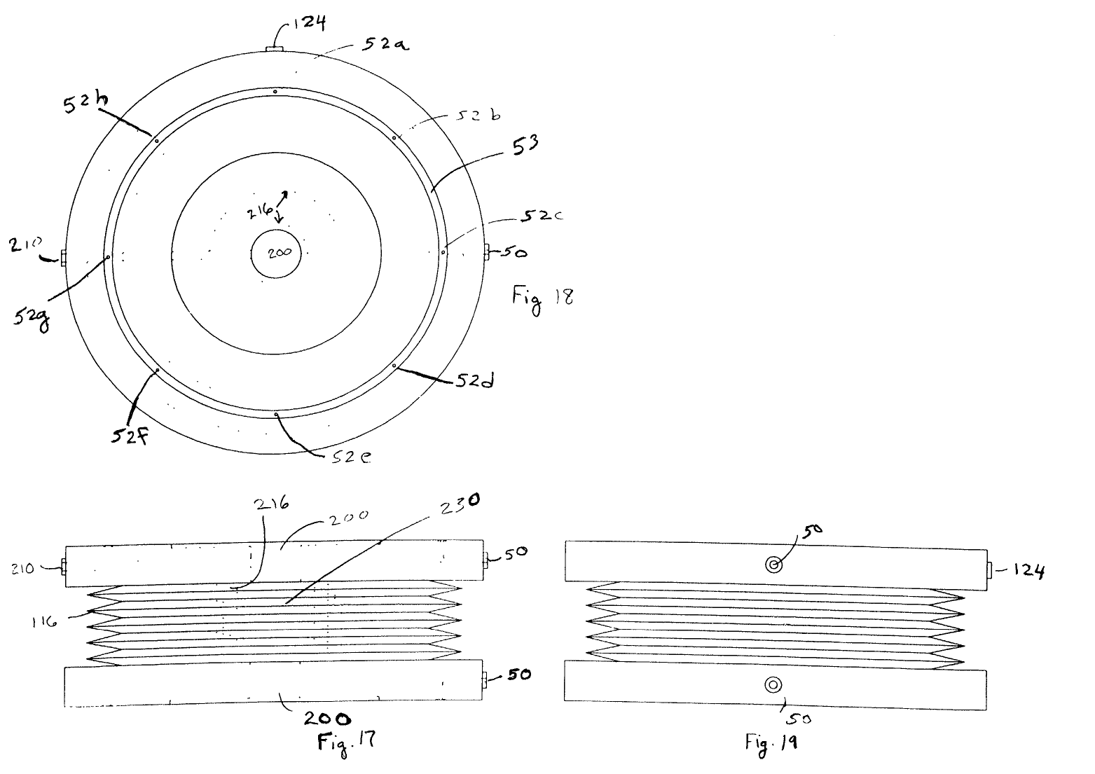

FIGS. 17, 18, and 19 show another embodiment in which the vacuum cavities 200 are connected together by a channel 230 within the bearing. This channel is isolated from the hydraulic fluid within the bellows 116 by a second internal and concentric bellows 216. This version preloads both the air bearings and the hydraulic fluid supported bellows and should provide somewhat higher overall bearing stiffness.

The presence of the vacuum cavities 200 reduces the area of the bearing surface. Therefore, for a given gas supply pressure, the overall load bearing capacity is reduced. In addition, the gas pressure in the bearings near the cavity 200 is reduced because of gas flow into the vacuum. This further reduces the load bearing capacity. The latter loss can be largely eliminated, if a groove adjacent to the vacuum cavity is supplied with gas at say atmospheric pressure. Use of this groove is taught in the U.S. patent application Ser. No. 09/012,432, referenced above. The bearing will then have the properties of a bearing of the same size operating normally in atmosphere.

The various embodiments of the bearing assemblies described above may be used alone or in combination, and in various arrangements. For example, the hydraulic actuated bearings 112 may be used with the movable platform 142.

As can be observed from the above description, the bearing assemblies of the present invention have numerous advantages. Importantly, the bearing assemblies reduce the size of the base and provide for movement of the stage in an additional three degrees of freedom without the use of stacked stages. Further, the air bearings provide for quieter operation and more accurate positioning than provided with traditional mechanical contact bearings.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A stage device comprising:
a base;
a stage positioned adjacent to the base and movable relative to the base;
a bearing assembly comprising at least one fluid bearing interposed between the base and the stage for supporting the stage on the base and movable relative to the base and the stage.

2. The stage device of claim 1 further comprising a motor for moving the stage relative to the base in at least one degree of freedom over a stroke of the stage.

3. The stage device of claim 2 further comprising a motor operable to move the bearing assembly relative to the stage and the base in a direction generally the same as a direction of movement of the stage at a velocity approximately one half of the velocity of the stage.

4. The stage device of claim 3 wherein the bearing motor has a lower bandwidth than the stage motor.

5. The stage device of claim 2 wherein the base has a generally planar surface, the bearing assembly being positioned for movement over said planar surface, said surface having an X dimension approximately equal to the X diameter of the bearing plus one half of the X stroke of the stage; and having a Y dimension approximately equal to the Y diameter of the bearing plus one half of the Y stroke of the stage.

6. The stage device of claim 2 wherein the stage motor is operable to move the stage relative to the base in five additional degrees of freedom.

7. The stage device of claim 2 wherein the stage motor is a planar motor.

8. The stage device of claim 2 wherein the stage motor is a linear motor.

9. The stage device of claim 1 wherein the bearing assembly comprises a retaining member, said at least one fluid bearing being attached to the retaining member for movement therewith.

10. The stage device of claim 9 further comprising a motor for driving the retaining member in a direction generally following the direction of the stage.

11. The stage device of claim 10 further comprising a shaft having one end attached to the motor and the other end attached to the retaining member for moving the retaining member.

12. The stage device of claim 9 wherein the retaining member is a generally rectangular plate and said at least one fluid bearing comprises four bearings, each bearing being attached to a comer of the plate.

13. The stage device of claim 12 wherein the base comprises four base pads disposed on an upper surface of the base, and wherein the stage comprises four stage pads disposed on a lower surface of the stage, each pad being positioned for receiving one of the bearings thereon for movement of the bearing between the base and stage.

14. The stage device of claim 1 wherein the fluid bearing is an air bearing.

15. The stage device of claim 1 wherein the bearing is preloaded.

16. The stage device of claim 15 wherein the preload is provided by a gravitational weight of the stage.

17. The stage device of claim 15 wherein the preload is provided by at least one spring attached between the stage and the base.

18. The stage device of claim 15 wherein the preload is provided by at least one bearing placed between the stage and the base.

19. The stage device of claim 15 wherein the bearing assembly incorporates a vacuum preloading mechanism.

20. The stage device of claim 19 wherein the fluid bearing comprises two bearing members, each including a port and a cavity, the port communicating with the cavity and connected to a vacuum pump such that the cavity can be evacuated through the port.

21. The stage device of claim 20 wherein each bearing member has an outer surface having a groove and an annular array of orifices within the groove, and a plenum that connects the orifices to a fluid inlet.

22. The stage device of claim 20 wherein each bearing member has an outer bellows and a channel connecting the cavities, the channel being isolated within the outer bellows by an inner bellows.

23. The stage device of claim 1 wherein the fluid bearing is operable in a vacuum.

24. The stage device of claim 1 wherein said at least one bearing comprises a plurality of bearings, each bearing being adjustable in a direction generally orthogonal to a plane of the base upon which the bearings slide.

25. The stage device of claim 24 wherein each bearing is generally cylindrical in shape and comprises a sidewall flexible in an axial direction to allow for adjustment of the height of the bearings.

26. The stage device of claim 24 wherein each bearing comprises a bellows.

27. The stage device of claim 26 wherein each bearing comprises a port for providing fluid to the bellows to increase pressure within the bearing and increase the height of the bearing.

28. The stage device of claim 1 wherein the fluid bearing has two generally planar surfaces on each end thereof, one outer surface being angularly rotatable relative to the other surface to compensate for variations in planar surfaces of the base and stage over which the bearing slides.

29. The stage device of claim 1 wherein the fluid bearing comprises two bearing members, each bearing member having an outer surface with an orifice for delivering fluid therefrom, and an inner surface, the two bearing members being positioned with the inner surfaces adjacent one another, and a flexible coupling connecting the two bearing members together to allow for angular rotation of each bearing member relative to the other bearing member to compensate for variations in planar surfaces of the base and stage over which the bearings slide.

30. The stage device of claim 29 wherein the flexible coupling comprises a bearing interposed between the two bearing members and received within generally spherical recesses formed in the inner surfaces thereof.

31. The stage device of claim 1 further comprising a platform extending from the base and movable relative thereto in a direction generally perpendicular to a planar surface of the base upon which the bearing moves.

32. The stage device of claim 31 wherein the platform is movable about two axes forming a plane of the planar surface of the base.

33. The stage device of claim 31 further comprising an actuation device operable to move the platform.

34. The stage device of claim 33 wherein the actuation device comprises a piezoelectric actuator.

35. The stage device of claim 33 wherein the actuation device comprises a hydraulic actuator.

36. The stage device of claim 33 wherein the actuation device comprises a piezoelectric actuator operable to make small changes in a position of the platform and a hydraulic actuator operable to make relatively large changes in a position of the platform.

37. The stage device of claim 33 further comprising a plurality of actuation devices independently controlled to provide movement of the platform about two axes forming a plane of the planar surface of the base upon which the bearing moves.

38. An exposure apparatus comprising:
a frame;
an optical system mounted on the frame;
a base;
a stage supported by the base and positioned adjacent thereto, the stage being movable relative to the base and the optical system; and
a bearing assembly comprising at least one fluid bearing interposed between the base and the stage for supporting the stage on the base and movable relative to the base and the stage.

39. The exposure apparatus of claim 38 further comprising a motor for moving the stage relative to the base in at least one degree of freedom over a stroke of the stage.

40. The exposure apparatus of claim 39 further comprising a motor operable to move the bearing assembly relative to the stage and the base in a direction generally the same as a direction of movement of the stage at a velocity approximately one half of the velocity of the stage.

41. The exposure apparatus of claim 38 wherein said at least one bearing comprises a plurality of bearings, each bearing being movable in a direction generally orthogonal to a plane of the base upon which the bearings slide.

42. The exposure apparatus of claim 38 further comprising a platform extending from the base and movable relative thereto in a direction generally perpendicular to a planar surface of the base upon which the bearing moves.

43. A method of positioning a stage within a lithography system having a base and an optical system for imaging a pattern onto an article supported by the stage, the stage being located adjacent to the base and movable relative thereto, the method comprising:
placing a fluid bearing between the stage and the base, the bearing being movable relative to the base and the stage;
moving the stage in a first direction; and
moving the bearing in the first direction.

44. The method of claim 43 wherein moving the bearing comprises moving the bearing at approximately half the velocity of the stage.

45. The method of claim 43 further comprising moving the stage and the bearing in a second direction generally perpendicular to said first direction.

46. The method of claim 45 further comprising moving the bearing in a third direction generally orthogonal to the first and second directions.

47. The method of claim 46 wherein moving the bearing in said third direction comprises pumping fluid into the bearing to expand bellows in the bearing.

48. The method of claim 45 further comprising moving a portion of the base in a direction generally orthogonal to said first and second directions.
